(19) United States
(12) Patent Application Publication
(10) Pub. No.: US 2023/0131744 A1
(43) Pub. Date: Apr. 27, 2023

(54) MASSAGE APPARATUS AND AUTHENTICATION METHOD THEREOF

(71) Applicant: BIBOTING INTERNATIONAL CO., LTD., Taoyuan City (TW)

(72) Inventors: Shih-Ta LIU, TAOYUAN CITY (TW); Po-Chang LIU, TAOYUAN CITY (TW); Pei-En LEE, New Taipei City (TW)

(21) Appl. No.: 17/511,957

(22) Filed: Oct. 27, 2021

(51) Int. Cl. G06F 21/44

(52) U.S. Cl. CPC G06F 21/445

(57) ABSTRACT

The disclosure provides a massage apparatus including a main massage device and an auxiliary massage device. The auxiliary massage device is electrically connected to the main massage device after passing an authentication procedure. The authentication procedure includes following steps. The main massage device is connected to an Internet. The main massage device is registered on a cloud data base. The main massage device transmits an authentication signal to the auxiliary massage device. The main massage device determines whether the auxiliary massage device is being unlocked according to an authentication information transmitted by the auxiliary massage device.

### BACKGROUND

### Technical Field

The disclosure relates to a massage apparatus, particularly relates to a massage apparatus and an authentication method thereof.

### Description of Related Art

The related-art massage apparatus mainly includes a host and a massage device. The host is configured to set different massage functions and use the massage device to achieve the massage effects for each portion of the human body. However, the related-art massage apparatus does not authenticate the host, and therefore the user may use pirated host to connect with a genuine massage device. The usage of the pirated host may impact the manufacturer. Further, when the user's genuine massage device is broken because of the pirated host, that may cause trouble to the manufacturer for managing the warranty of the sold product.

In view of this, the inventors have devoted themselves to the aforementioned related art, researched intensively try to solve the aforementioned problems.

### SUMMARY

The disclosure discloses a massage apparatus and an authentication method thereof, which may perform the online registration to the main massage device. Further, before the auxiliary massage device is being used, the auxiliary massage device needs to be authenticated by the main massage device for usage. Therefore, the usages of pirated main massage device connecting with genuine auxiliary massage device or genuine main massage device connecting with pirated auxiliary massage device may be prevented, and the manufacturer may effectively manage the warranty of the massage apparatus.

In order to achieve the aforementioned object, the disclosure provides an authentication method for a massage apparatus. The authentication method includes: obtaining a main massage device; connecting the main massage device to an Internet; registering the main massage device on a cloud database; obtaining an auxiliary massage device; transmitting, by the main massage device, an authentication signal to the auxiliary massage device; and determining, by the main massage device, whether to unlock the auxiliary massage device according to an authentication information transmitted by the auxiliary massage device.

In some embodiments, when the main massage device is configured to determine to unlock the auxiliary massage device according to the authentication information, the auxiliary massage device is electrically connected to the main massage device and configured to execute a predetermined function.

In some embodiments, when the main massage device is configured to determine to lock the auxiliary massage device according to the authentication information, the main massage device and the auxiliary massage device are electrically disconnected.

In some embodiments, when the main massage device is configured to transmit the authentication signal to the auxiliary massage device, the main massage device and the Internet are disconnected.

In some embodiments, the determining of whether the auxiliary massage device is being unlocked according to the authentication information further includes: connecting the main massage device and the cloud database through the Internet; and determining, by the main massage device, whether to unlock the auxiliary massage device according to the cloud database and the authentication information.

In some embodiments, the connecting of the main massage device to the Internet further includes: obtaining a mobile device; and configuring a connection information of connecting the main massage device to the Internet through the mobile device.

In some embodiments, the registering of the main massage device to the cloud database further includes: obtaining a host information of the main massage device through the mobile device; and uploading the host information to the cloud database to register the main massage device.

In some embodiments, the authentication method further includes: registering the auxiliary massage device on the cloud database.

In some embodiments, the authentication method further includes: obtaining a mobile device; obtaining a device information of the auxiliary massage device through the mobile device; and uploading the device information to the cloud database to register the auxiliary massage device.

In order to achieve the aforementioned object, the disclosure provides a massage apparatus. The massage apparatus includes a main massage device and an auxiliary massage device. The auxiliary massage device is electrically connected to the main massage device after passing an authentication procedure. The authentication procedure includes: connecting the main massage device to an Internet; registering the main massage device on a cloud database; transmitting, by the main massage device, an authentication signal to the auxiliary massage device; and determining, by the main massage device, whether to unlock the auxiliary massage device according to an authentication information transmitted by the auxiliary massage device.

In summary, the massage apparatus and authentication method of the disclosure may connect the main massage device to the cloud database to perform the online registration and activate the main massage device. Further, before using the auxiliary massage device, the user needs to connect the auxiliary massage device to the main massage device for matching and authenticate the auxiliary massage device by the main massage device for usage. Therefore, the massage apparatus and authentication method of the disclosure may prevent the user from using pirated main massage device to connect with a genuine auxiliary massage device or using a genuine main massage device to connect with pirated auxiliary massage device, and enable the manufacturer to effectively manage the warranty of the massage apparatus.

### BRIEF DESCRIPTION OF THE DRAWINGS

FIG. 1 is a flowchart of an authentication method of a massage apparatus, in accordance with some embodiments.

FIG. 2 is a schematic diagram of the authentication status of the massage apparatus, in accordance with some embodiments.

FIG. 3 is a schematic diagram of the authentication status of the massage apparatus, in accordance with some embodiments.

FIG. 4 is a schematic diagram of another authentication status of the massage apparatus, in accordance with some embodiments.

FIG. 5 is a schematic diagram of another authentication status of the massage apparatus, in accordance with some embodiments.

FIG. 6 is a schematic diagram of another authentication status of the massage apparatus, in accordance with some embodiments.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

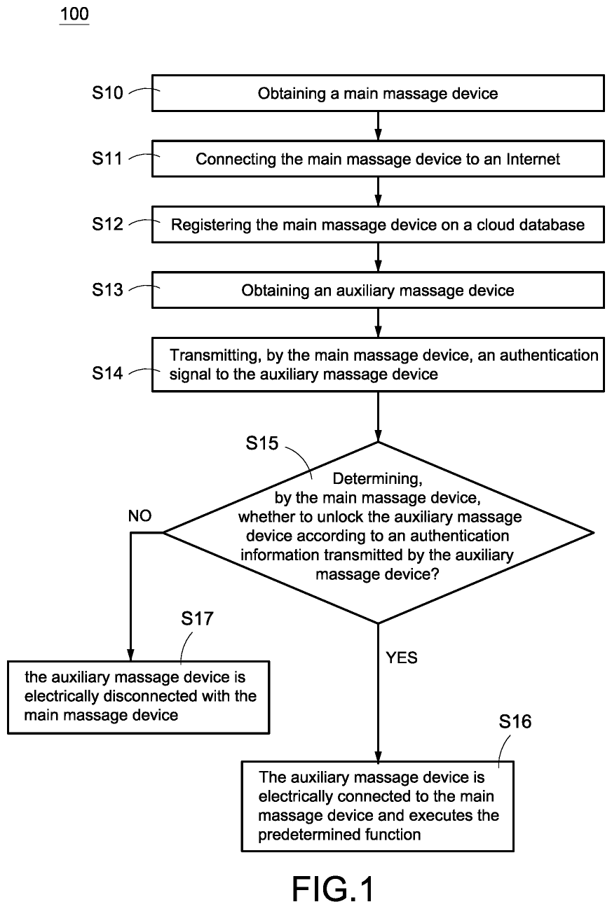

FIG. 1 is a flowchart of an authentication method 100 of a massage apparatus, in accordance with some embodiments. The authentication method 100 includes the step S10 to step S15. The step S10 is obtaining a main massage device. The step S11 is connecting the main massage device to the Internet. The step S12 is registering the main massage device on a cloud database. The step S13 is obtaining an auxiliary massage device. The step S14 is transmitting, by the main massage device, an authentication signal to the auxiliary massage device. The step S15 is determining, by the main massage device, whether to unlock the auxiliary massage device according to an authentication information transmitted by the auxiliary massage device.

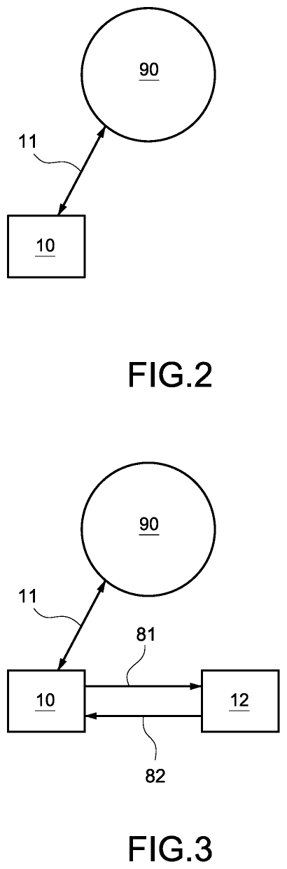

FIG. 2 is a schematic diagram of the authentication status of the massage apparatus, in accordance with some embodiments. Please refer to FIG. 1 and FIG. 2, in the step S10, the main massage device 10 is obtained. In some embodiments, the massage apparatus may be, for example, a negative-pressure apparatus, an aesthetic health care apparatus for facial portion, or the other massage apparatuses having the main massage device 10 and auxiliary massage device. In some embodiments, the main massage device 10, for example, may include an external negative-pressure device, or the other hosts providing different massage and health care functions, here is not intended to be limiting.

In the step S11, the main massage device 10 is connected to the Internet 11. In the step S12, the main massage device 10 is registered on the cloud database 90. In some embodiments, the main massage device 10 may include an operation panel (not shown in figures). The user may use the operation panel to configure the connection information for connecting the Internet 11. In some embodiments, the main massage device 10 may be connected to the Internet 11 in a wired or wireless (for example, using Wi-Fi, 4G or 5G communication, etc.) manner, here is not intended to be limiting.

When the main massage device 10 is connected with the Internet 11, the user may register the main massage device 10 on the cloud database 90 by the operation panel. In other words, the user may record the host information of the main massage device 10 on the cloud database 90 to authenticate the main massage device 10 as the genuine device and activate the main massage device 10. It is worth mentioning that the host information needed to be recorded on the cloud database 90 may be different depending on the requirements of the manufacturer. For example, the host information may include the purchasing date, product serial number, purchasing location, and/or activation date, etc., here is not intended to be limiting. It should be noted that the user only needs to register the main massage device 10 on the cloud database 90 when using the main massage device 10 for the first time. In other words, after the main massage device 10 has been authenticated on the cloud database 90, the user does not need to perform the registration action again.

FIG. 3 is a schematic diagram of the authentication status of the massage apparatus, in accordance with some embodiments. Please refer to FIG. 1 and FIG. 3, in the step S13, the auxiliary massage device 12 is obtained. In some embodiments, the auxiliary massage device 12 may include a massage stick, a cosmetic stick, or the other auxiliary devices providing different massage and health care functions, here is not intended to be limiting. In some embodiments, the main massage device 10 and the auxiliary massage device 12, for example, are connected with each other by communicating tube, conductive wire, etc., here is not intended to be limiting. Further, the auxiliary massage device 12 may be electrically connected with the main massage device 10 only after passing the authentication procedure.

In the step S14, the main massage device 10 transmits the authentication signal 81 to the auxiliary massage device 12. In the step S15, the main massage device 10 is configured to determine whether to unlock the auxiliary massage device 12 according to the authentication information 82 transmitted by the auxiliary massage device 12. In some embodiments, the authentication signal 81 transmitted by the main massage device 10 may be a verification code or a predetermined ID signal. When the auxiliary massage device 12 receives the authentication signal 81 in the communication range of the main massage device 10, the auxiliary massage device 12 may transmit the authentication information 82 (for example, encrypted message) to communicate with the main massage device 10 for authentication.

In some embodiments, when the authentication information 82 of the auxiliary massage device 12 is received, the main massage device 10 may connect with the cloud database 90 to confirm if the authentication information 82 of the auxiliary massage device 12 is corresponding to the genuine device. For example, the manufacturer may configure the auxiliary massage device 12 to transmit the predetermined authentication information 82 corresponding to the authentication signal 81, and the main massage device 10 may confirm if the authentication information 82 transmitted by the auxiliary massage device 12 is the corresponding information of the genuine device. In other words, the user may not need to register the auxiliary massage device 12 on the cloud database 90, and may authenticate the auxiliary massage device 12 through the connection between the main massage device 10 and the cloud database 90.

In some other embodiments, the auxiliary massage device 12 may be registered on the cloud database 90 through the main massage device 10. That is, when the authentication information 82 of the auxiliary massage device 12 is received, the main massage device 10 may connect with the cloud database 90 to confirm if the authentication information 82 of the auxiliary massage device 12 is corresponding to the genuine device and confirm if the auxiliary massage device 12 is registered. If the auxiliary massage device 12 is not registered, the user may register the auxiliary massage device 12 on the cloud database 90 by the operation panel of the main massage device 10. It should be noted that the user only needs to register the auxiliary massage device 12 on the cloud database 90 when using the auxiliary massage device 12 for the first time, but the auxiliary massage device 12 needs to be authenticated by the main massage device 10 every time the user uses the auxiliary massage device 12.

Please refer to FIG. 1 and FIG. 3, in the step S16, when the main massage device 10 is configured to determine to unlock the auxiliary massage device 12 according to the authentication information 82, the auxiliary massage device 12 is electrically connected to the main massage device 10 and executes the predetermined function. In other words, if the auxiliary massage device 12 passes the authentication procedure, the main massage device 10 determines that the auxiliary massage device 12 is the genuine device, the user may collectively use the main massage device 10 and the auxiliary massage device 12, and execute the predetermined function by the auxiliary massage device 12. The predetermined function, for example, is the vibration function with different levels, heating function, or the other massage and health care functions, here is not intended to be limiting. It is worth mentioning that different registered main massage device 10 may be alternatively used with different registered auxiliary massage device 12 to increase the convenience of usage.

In the step S17, when the main massage device 10 is configured to determine to lock the auxiliary massage device 12 according to the authentication information 82, the auxiliary massage device 12 is electrically disconnected from the main massage device 10. That is, if the auxiliary massage device 12 does not pass the authentication procedure, the main massage device 10 determines that the auxiliary massage device 12 is the pirated device, the main massage device 10 and the auxiliary massage device 12 are electrically disconnected (or the auxiliary massage device 12 is locked), and the user is not able to use the auxiliary massage device 12. It is worth mentioning that, depending on the different configurations, after the auxiliary massage device 12 and the main massage device 10 are connected and before the authentication procedure is accomplished, the user may be allowed to execute the predetermined function in a predetermined time period, and the usage of the auxiliary massage device 12 is terminated when the authentication procedure fails, here is not intended to be limiting.

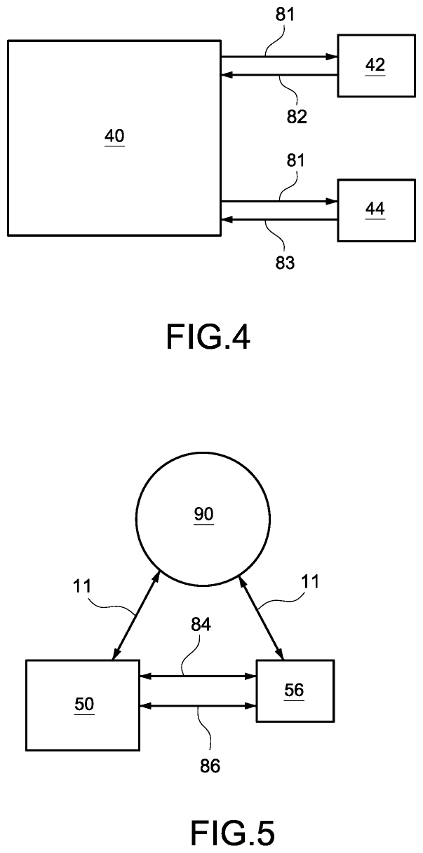

FIG. 4 is a schematic diagram of another authentication status of the massage apparatus, in accordance with some embodiments. In some embodiments, when the main massage device 40 transmits the authentication signal 81 to the auxiliary massage devices 42, 44, the main massage device 40 may be disconnected from the Internet. In other words, the main massage device 40 may authenticate the auxiliary massage devices 42, 44 under an offline status. For example, when main massage device 40 transmits the authentication signal 81 to the auxiliary massage device 42 and the auxiliary massage device 42 receives the authentication signal 81 in the communication range of the main massage device 40, the auxiliary massage device 42 may transmit the authentication information 82 to communicate with the main massage device 40 for authentication. When the authentication information 82 of the auxiliary massage device 42 is received, the main massage device 40 may directly confirm (for example, using the information recorded in the memory of the main massage device 40) if the authentication information 82 of the auxiliary massage device 42 is corresponding to the genuine device. When the main massage device 40 is configured to determine to unlock the auxiliary massage device 42 according to the authentication information 82, the auxiliary massage device 42 is electrically connected to the main massage device 40 and executes the predetermined function.

On the other hand, when the main massage device 40 is configured to determine to lock the auxiliary massage device 44 according to the authentication information 83, the auxiliary massage device 44 is electrically disconnected from the main massage device 40 (or locked by the main massage device 40). It is worth mentioning that different registered main massage device 40 may be alternatively used with different registered auxiliary massage device 42 to increase the convenience of usage.

In short, the massage apparatus and authentication method 100 thereof in some embodiments may connect the main massage device 10 to the cloud database 90 to perform the online registration and activate the main massage device 10. Further, before using the auxiliary massage device 12, the user needs to connect the auxiliary massage device 12 to the main massage device 10 for matching and authenticate the auxiliary massage device 12 by the main massage device 10 for usage. Therefore, the massage apparatus and authentication method 100 thereof in some embodiments may prevent the user from using pirated main massage device to connect with genuine auxiliary massage device 12 or using genuine main massage device 10 to connect with pirated auxiliary massage device, and enable the manufacturer to effectively manage the warranty of the massage apparatus.

FIG. 5 is a schematic diagram of another authentication status of the massage apparatus, in accordance with some embodiments. In some embodiments, the user may obtain a mobile device 56 in advance and configure the connection information 84 for connecting the main massage device 50 to the Internet 11 by the mobile device 56. The mobile device 56 may be a smartphone and have an application program. The user may use the mobile device 56 to scan the QR code, serial number barcode, NFC tag, or physical button, etc., of the main massage device 50 to obtain the host information 86 of the main massage device 50. Further, the user may configure the connection information 84 of the main massage device 50 in the application program to connect the main massage device 50 to the Internet 11.

Further, the user may use the application program of the mobile device 56 to register the main massage device 50 on the cloud database 90. That is, the user may record the host information 86 obtained by scanning the QR code, serial number barcode, NFC tag, or physical button, etc., of the main massage device 50 to the cloud database 90 through the application program of the mobile device 56 to authenticate the main massage device 50 as the genuine device and activate the main massage device 50. It should be noted that the user only needs to register the main massage device 50 on the cloud database 90 when using the main massage device 10 for the first time. In other words, after the main massage device 50 has been authenticated on the cloud database 90, the user does not need to perform the registration action again.

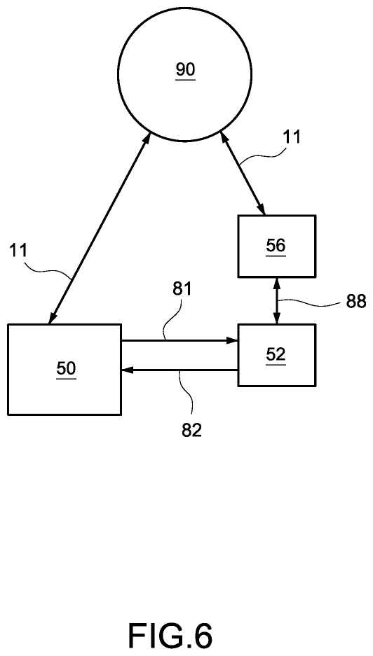

FIG. 6 is a schematic diagram of another authentication status of the massage apparatus, in accordance with some embodiments. In some embodiments, the user may also use the mobile device 56 to register the auxiliary massage device 52 on the cloud database 90. The user, for example, may use scan the QR code, serial number barcode, NFC tag, or physical button, etc., of the auxiliary massage device 52 to obtain the device information 88 of the auxiliary massage device 52. Further, the user may record the device information 88 of the auxiliary massage device 52 to the cloud database 90 through the application program of the mobile device 56 to authenticate the auxiliary massage device 52 as the genuine device and activate the auxiliary massage device 52. It should be noted that the user only needs to register the auxiliary massage device 52 on the cloud database 90 when using the auxiliary massage device 52 for the first time, but the auxiliary massage device 52 needs to be authenticated by the main massage device 50 every time the user uses the auxiliary massage device 52.

In some embodiments, when main massage device 50 transmits the authentication signal 81 to the auxiliary massage device 52 and the auxiliary massage device 52 receives the authentication signal 81 in the communication range of the main massage device 50, the auxiliary massage device 52 may transmit the authentication information 82 to communicate with the main massage device 50 for authentication. When the authentication information 82 of the auxiliary massage device 52 is received, the main massage device 50 may connect with the cloud database 90 to confirm if the authentication information 82 of the auxiliary massage device 52 is registered. When the main massage device 50 determines that the auxiliary massage device 52 is registered according to the authentication information 82, the matching between the main massage device 50 and the auxiliary massage device 52 are completed, and the auxiliary massage device 52 may be electrically connected to the main massage device 50 and execute the predetermined function. On the other hand, when the main massage device 50 determines that the auxiliary massage device 52 is not registered according to the authentication information 82, the main massage device 50 and the auxiliary massage device 52 are electrically disconnected (or the auxiliary massage device 52 is locked), here is not intended to be limiting.

For example, when the authentication information 82 of the auxiliary massage device 52 is received, the main massage device 50 may connect with the cloud database 90 to confirm if the authentication information 82 of the auxiliary massage device 52 is corresponding to the genuine device. The manufacturer may configure the auxiliary massage device 52 to transmit the predetermined authentication information 82 corresponding to the authentication signal 81, and the main massage device 50 may confirm if the authentication information 82 transmitted by the auxiliary massage device 52 is the corresponding information of the genuine device. In other words, the user may not need to register the auxiliary massage device 52 on the cloud database 90, and may authenticate the auxiliary massage device 52 through the connection between the main massage device 50 and the cloud database 90.

Therefore, the user may use the mobile device 56 to configure the main massage device 50 and the auxiliary massage device 52 to increase the convenience of usage. Further, different registered main massage device 50 may be alternatively used with different registered auxiliary massage device 52 to increase the convenience of usage.

In summary, the massage apparatus and authentication method of the disclosure may connect the main massage device to the cloud database to perform the online registration and activate the main massage device. Further, before using the auxiliary massage device, the user needs to connect the auxiliary massage device to the main massage device for matching and authenticate the auxiliary massage device by the main massage device for usage. Therefore, the massage apparatus and authentication method of the disclosure may prevent the user from using pirated main massage device to connect with a genuine auxiliary massage device or using a genuine main massage device to connect with pirated auxiliary massage device, and enable the manufacturer to effectively manage the warranty of the massage apparatus.

While this disclosure has been described by means of specific embodiments, numerous modifications and variations may be made thereto by those skilled in the art without departing from the scope and spirit of this disclosure set forth in the claims.

What is claimed is:

1. An authentication method for a massage apparatus, the authentication method comprising:
obtaining a main massage device;
connecting the main massage device to an Internet;
registering the main massage device on a cloud database;
obtaining an auxiliary massage device;
transmitting, by the main massage device, an authentication signal to the auxiliary massage device; and
determining, by the main massage device, whether to unlock the auxiliary massage device according to an authentication information transmitted by the auxiliary massage device.

2. The authentication method according to claim 1, wherein when the main massage device is configured to determine to unlock the auxiliary massage device according to the authentication information, the auxiliary massage device is electrically connected to the main massage device and configured to execute a predetermined function.

3. The authentication method according to claim 1, wherein when the main massage device is configured to determine to lock the auxiliary massage device according to the authentication information, the main massage device and the auxiliary massage device are electrically disconnected.

4. The authentication method according to claim 1, wherein when the main massage device is configured to transmit the authentication signal to the auxiliary massage device, the main massage device and the Internet are disconnected.

5. The authentication method according to claim 1, wherein the determining of whether the auxiliary massage device is being unlocked according to the authentication information further comprises:
connecting the main massage device and the cloud database through the Internet; and
determining, by the main massage device, whether to unlock the auxiliary massage device according to the cloud database and the authentication information.

6. The authentication method according to claim 1, wherein the connecting of the main massage device to the Internet further comprises:
obtaining a mobile device; and
configuring a connection information of connecting the main massage device to the Internet through the mobile device.

7. The authentication method according to claim 6, wherein the registering of the main massage device to the cloud database further comprises:
obtaining a host information of the main massage device through the mobile device; and
uploading the host information to the cloud database to register the main massage device.

8. The authentication method according to claim 1, further comprising:
registering the auxiliary massage device on the cloud database.

9. The authentication method according to claim 8, further comprising:
obtaining a mobile device;
obtaining a device information of the auxiliary massage device through the mobile device; and
uploading the device information to the cloud database to register the auxiliary massage device.

10. A massage apparatus, comprising:
a main massage device; and
an auxiliary massage device, electrically connected to the main massage device after passing an authentication procedure, wherein the authentication procedure comprises:
connecting the main massage device to an Internet;
registering the main massage device on a cloud database;
transmitting, by the main massage device, an authentication signal to the auxiliary massage device; and
determining, by the main massage device, whether to unlock the auxiliary massage device according to an authentication information transmitted by the auxiliary massage device.
